(19) United States
(12) Patent Application Publication
(10) Pub. No.: US 2008/0217958 A1
(43) Pub. Date: Sep. 11, 2008

(54) Support apparatus for a shell piece of an automobile vehicle, system comprising the support apparatus, and fixation method of the support apparatus

(75) Inventors: Pascal Banry, Bourg Saint Christophe (FR); Jerome Brizin, Arbent (FR)

Correspondence Address: OLIFF & BERRIDGE, PLC, P.O. BOX 320850, ALEXANDRIA, VA, 22320-4850, US

(73) Assignee: COMPAGNIE PLASTIC OMNIUM, Lyon (FR)

(21) Appl. No.: 11/514,103

(22) Filed: Sep. 1, 2006

(30) Foreign Application Priority Data
Sep. 2, 2005 (FR) 0509019

(51) Int. Cl. B62D 25/00

(52) U.S. Cl. 296/187.01

(57) ABSTRACT

The rib support (32) is for being applied against an inside face of a bodywork skin (12) in the vicinity of at least one orifice (28) provided through said skin (12) for passing a rib (26) of a fitting (14) that is to be fitted onto a visible outside face of said skin (12), opposite from its inside face. Said support (32) comprises at least a rib (30) arranged to project from the inside face of the skin (12) in the vicinity of an orifice (28) in said skin (12), when the support (32) is applied against the inside face of the skin (12).

The present invention relates to a rib support for fastening a fitting on a motor vehicle bodywork skin, to an assembly comprising such a fitting and such a support, and to a method of fastening such a fitting.

It is known that certain decorative parts, such as protective strips, are fixed to a bodywork skin merely by snap-fastening resilient tabs formed on the decorative parts in orifices formed in the skin.

However, that method of fastening does not always ensure that the decorative part is properly applied against the skin.

Provision is then made for pairs of ribs that project from the rear face of the skin. In each pair of ribs, one belongs to the decorative part and passes through an orifice formed in the skin, while the other belongs to the skin. The part is fixed to the skin by securing the ribs together in pairs, by stapling or by heat-sealing.

In that known solution, the rib that belongs to the skin is integrally molded therewith. It must therefore be provided in the mold recess for the skin.

However, when the decorative part is optional on the vehicle, the presence of ribs can be useless. Indeed such presence can even be undesirable if the ribs lead to shrink marks on the visible face of the skin. Under such circumstances, it is necessary to provide two versions of the skin, one version with ribs, for the purpose of receiving the decorative part, and another version without ribs, that is not to receive the decorative part.

That solution is entirely satisfactory both technically and in terms of appearance. However it requires different versions of the skin to be managed, one for each possible combination of optional decorative parts, and that leads to complications in organization and to industrial costs that are not negligible.

The present invention seeks to provide a novel solution that avoids those drawbacks, while being at least as satisfactory both technically and in terms of appearance.

To this end, the invention provides a rib support for applying against an inside face of a bodywork skin in the vicinity of at least one orifice provided through said skin for passing a rib of a fitting that is to be fitted on the visible outside face of said skin, opposite from its inside face, wherein the rib support comprises at least one rib arranged to project from the inside face of the skin in the vicinity of an orifice in said skin when the support is applied against the inside face of the skin, and wherein at least one rib of the support is shaped to be secured to a corresponding rib of the fitting fitted on the skin.

The support of the invention is advantageous in that it provides the rib(s) for securing to the ribs of the fitting on the inside face of the skin. These ribs therefore do not need to form part of the same molding as the skin.

As a result, there is no need to manage different versions of the skin, and only the orifices need to be made in order to fasten a fitting. Such orifices can be obtained by punching or by drilling, for example.

A particularly advantageous application of the invention lies in fastening wheel arch extensions on bumper overriders or on fender margins for sport or all-terrain versions of vehicles that already exist in a touring version. Under such circumstances, all of the vehicles can use the same bumper skin and the same fenders, but those having extensions can have them secured by means of the invention to the bumper skin and to the fenders, with the only modification that needs to be undertaken on the bodywork parts is to make orifices for passing the ribs of the extensions.

In a particular embodiment of the invention, at least one rib of the support is shaped to receive a staple for securing it to a corresponding rib of the fitting fitted on the skin.

In another embodiment, at least one rib of the support is shaped to be capable of being heat-sealed to a corresponding rib of the fitting mounted to the skin.

The invention also provides an assembly comprising a fitting for fitting on a visible outside face of a bodywork skin and having at least one rib for passing through an orifice provided in said skin, and a rib support, distinct from the bodywork skin, as defined above.

The present invention also provides a method of fastening a fitting on a motor vehicle skin, the method being characterized in that it comprises:
a step during which the fitting is presented to the skin and a rib of said fitting is caused to pass through an orifice provided in said skin;
a step during which a rib support, as defined above, is applied against an inside face of the bodywork skin in the vicinity of the orifice; and
a step during which a rib of the rib support is secured to the rib of the fitting.

In a particular implementation of the invention, a rib of the support is secured to a rib of the fitting by stapling.

In another implementation of the invention, a rib of the support is secured to a rib of the fitting by heat-sealing.

The invention can be better understood on reading the following description given purely by way of example and made with reference to the accompanying drawing, in which:

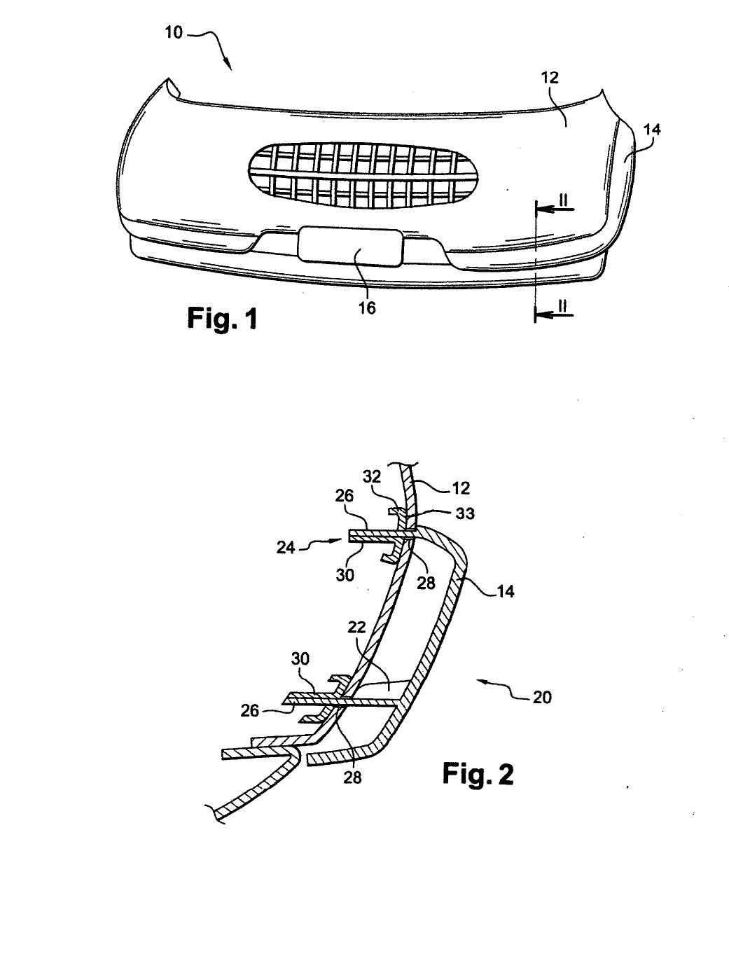

FIG. 1 is a perspective view of a front portion of a motor vehicle comprising a bodywork skin having fittings fastened thereto by the method of the invention; and

FIG. 2 is a section view of the front of the FIG. 1 motor vehicle on arrows II-II.

FIG. 1 shows the front portion of a motor vehicle given overall reference 10.

This front portion 10 comprises a bumper skin 12, for receiving fittings on its visible outer face, e.g. a motor vehicle wheel arch extension 14 or a number plate support 16.

The fittings 14, 16 are positioned on the skin 12 by positioning means 20 and then they are fastened to the skin 12 by fastener means 24. The positioning means and the fastener means are shown in greater detail in FIG. 2, by way of example for fastening the wheel arch extension 14.

The positioning means 20 comprise positioning ribs 22 formed on the fitting 14, serving to act as spacers between said fitting 14 and the outside face of the skin 12.

The positioning means preferably also comprise conventional snap-fastening means (not shown) for fastening the fitting 14 to the skin 12.

Furthermore, the fastener means 24 also comprise pairs of fastener ribs. Each pair comprises one rib 26 formed on the fitting 14 and passing through corresponding orifices 28 formed in the skin 12, and another rib 30 formed on a rib support 32 and applied against the inside face of the bodywork skin 12, in the vicinity of the orifices 28.

For this purpose, the rib support 32 is generally in the form of an elongate section member extending substantially horizontally along the skin 12 on its inside, as considered when the bumper skin is mounted on a motor vehicle. Thus, the rib support 32 comprises at least a first portion forming a base 33 that is preferably relatively thin, having a contact surface that is to be applied against the inside face of the bumper skin 12, and at least a second portion forming the rib 30 that projects from the thin first portion. The contact surface of the thin first portion is preferably complementary to the inside face of the bumper skin 12, such that the rib 30 retains a direction that is determined and precise when the thin portion is applied against said inside face.

The fastener ribs 26 and 30 are thus arranged in such a manner as to project from the inside face of the skin 12 close to each other, these ribs 26 and 30 being shaped to be secured to each other.

The fitting 14 is thus fastened by securing these ribs 26 and 30 to each other in pairs. The ribs 26, 30 have complementary surfaces, e.g. plane surfaces, that are suitable for co-operating with each other so as to facilitate securing the ribs together. The ribs 26, 30 are preferably secured to each other by stapling or by heat-sealing the ribs.

It should be observed that the rib support 32 is generally shaped as a frame matching the shape of the inside face of the skin 12, and having a plurality of ribs 30 for fastening the fitting 14. In a variant, the frame-shaped support 32 could be replaced by a plurality of supports each having a single rib 30.

Finally, it should be observed that the embodiment described by way of example above is not limiting and that the invention can be implemented in various different manners.

1. A rib support for applying against an inside face of a bodywork skin in the vicinity of at least one orifice provided through said skin for passing a rib of a fitting that is to be fitted on the visible outside face of said skin, opposite from its inside face, wherein the rib support comprises at least one rib arranged to project from the inside face of the skin in the vicinity of an orifice in said skin when the support is applied against the inside face of the skin, and wherein at least one rib of the support is shaped to be secured to a corresponding rib of the fitting fitted on the skin.

2. A rib support according to claim 1, in which at least one rib of the support is shaped to receive a staple for securing it to a corresponding rib of the fitting fitted on the skin.

3. A rib support according to claim 1, in which at least one rib of the support is shaped to be capable of being heat-sealed to a corresponding rib of the fitting fitted to the skin.

4. A rib support according to claim 1, shaped as a frame adapted to the shape of the inside face of the bodywork skin.

5. An assembly comprising a fitting for fitting on a visible outside face of a bodywork skin and having at least one rib for passing through an orifice provided in said skin, and a rib support, distinct from the bodywork skin, and in accordance with claim 1.

6. A method of fastening a fitting on a motor vehicle skin, the method comprising:
a step during which the fitting is presented to the skin and a rib of said fitting is caused to pass through an orifice provided in said skin;
a step during which a rib support according to claim 1 is applied against an inside face of the bodywork skin in the vicinity of the orifice; and
a step during which a rib of the rib support is secured to the rib of the fitting.

7. A method of fastening according to claim 6, in which a rib of the support is secured to a rib of the fitting by stapling.

8. A method of fastening according to claim 6, in which a rib of the support is secured to a rib of the fitting by heat-sealing.

9. A method of fastening a fitting on a motor vehicle skin, the method comprising:
a step during which the fitting is presented to the skin and a rib of said fitting is caused to pass through an orifice provided in said skin;
a step during which a rib support according to claim 2 is applied against an inside face of the bodywork skin in the vicinity of the orifice; and
a step during which a rib of the rib support is secured to the rib of the fitting.

10. A method of fastening a fitting on a motor vehicle skin, the method comprising:
a step during which the fitting is presented to the skin and a rib of said fitting is caused to pass through an orifice provided in said skin;
a step during which a rib support according to claim 3 is applied against an inside face of the bodywork skin in the vicinity of the orifice; and
a step during which a rib of the rib support is secured to the rib of the fitting.

11. A method of fastening a fitting on a motor vehicle skin, the method comprising:
a step during which the fitting is presented to the skin and a rib of said fitting is caused to pass through an orifice provided in said skin;
a step during which a rib support according to claim 4 is applied against an inside face of the bodywork skin in the vicinity of the orifice; and
a step during which a rib of the rib support is secured to the rib of the fitting.

12. A method of fastening according to claim 9, in which a rib of the support is secured to a rib of the fitting by stapling.

13. A method of fastening according to claim 9, in which a rib of the support is secured to a rib of the fitting by heat-sealing.

14. A method of fastening according to claim 10, in which a rib of the support is secured to a rib of the fitting by stapling.

15. A method of fastening according to claim 10, in which a rib of the support is secured to a rib of the fitting by heat-sealing.

16. A method of fastening according to claim 11, in which a rib of the support is secured to a rib of the fitting by stapling.

17. A method of fastening according to claim 11, in which a rib of the support is secured to a rib of the fitting by heat-sealing.
